(19) United States
(12) Patent Application Publication
(10) Pub. No.: US 2002/0073809 A1
(43) Pub. Date: Jun. 20, 2002

(54) ALEX WRENCH

(76) Inventors: Armen Kuryan, Glendale, CA (US); Srbui Charlette Kuryan-Badivian, Glendale, CA (US)

Correspondence Address: SRBUI BADIVIAN, 1118 E RALEIGH ST, GLENDALE, CA, 91205, US

(21) Appl. No.: 09/738,185

(22) Filed: Dec. 15, 2000

(51) Int. Cl. B25B 13/52

(52) U.S. Cl. 81/64

(57) ABSTRACT

A new and improved type of oil filter wrench consisting of a handle and a sharp toothed coil with a self adjusting band. The coil with the attached self-adjusting band has vertical and horizontal insert slots where the handle portion is inserted. The wrench after preferred assemble is secured onto the filter with effortless twist. The toothed coil then grasps the filter and the self adjusting band secures itself to the size of the oil filter making the installation or removal very easy and quick.

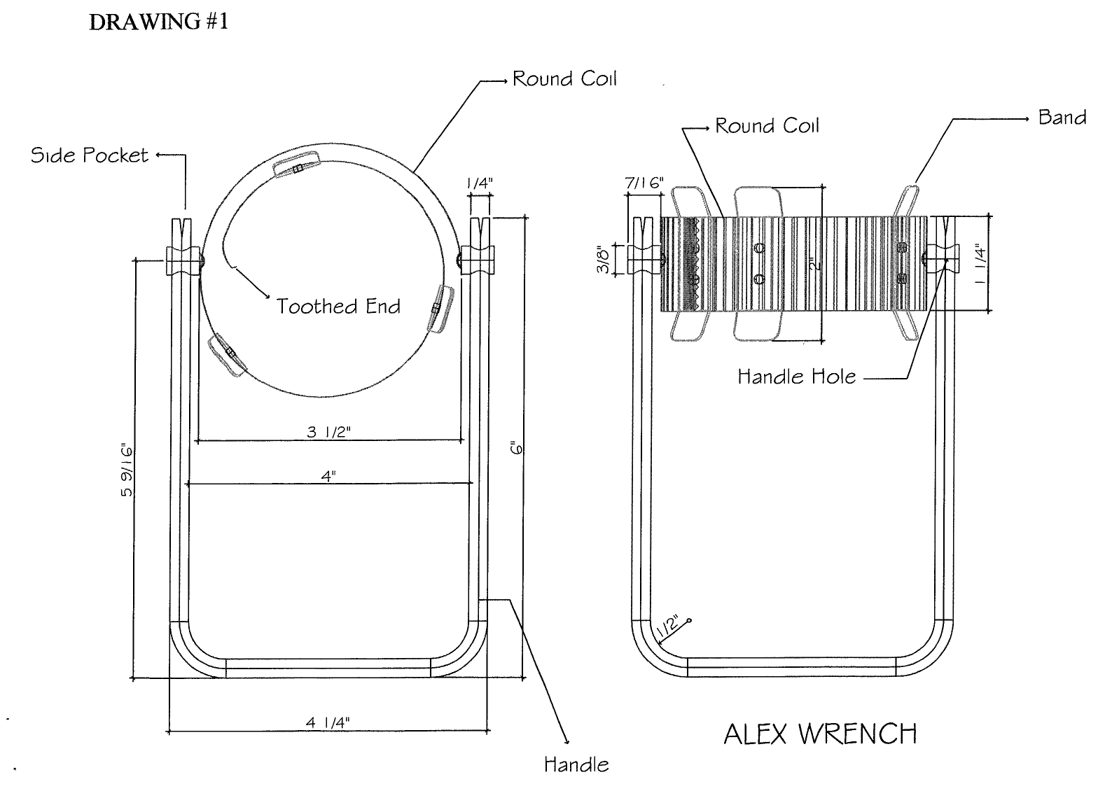

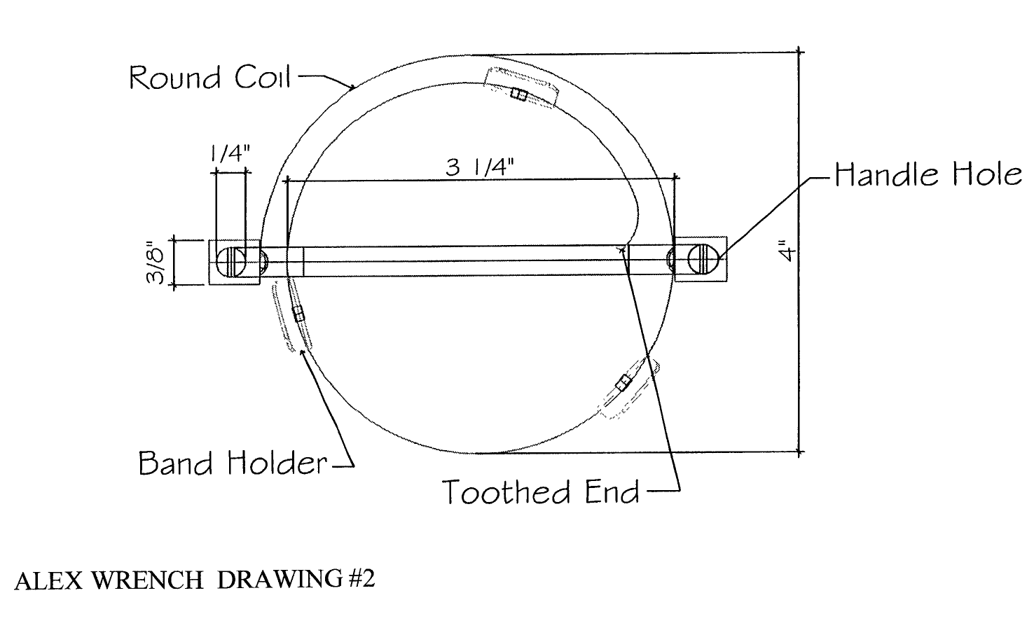

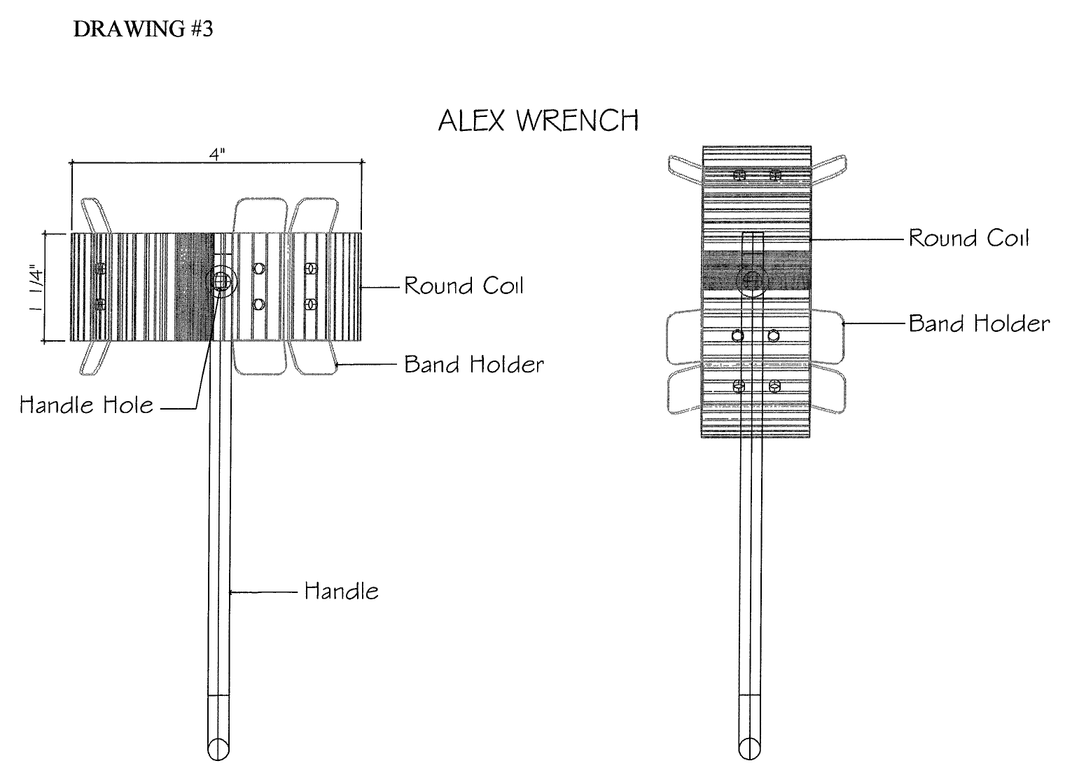

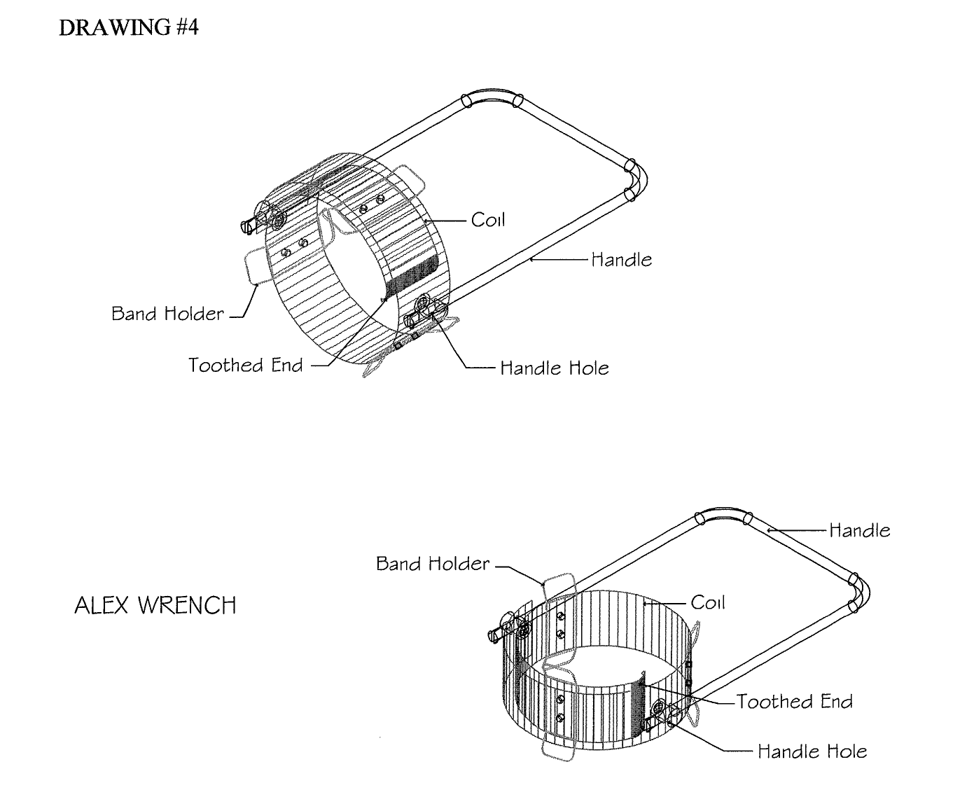

### BACKGROUND OF THE INVENTION

1. Technical Field of the Invention The invention relates to wrenches and tools specially designed to assist in motor vehicle maintenance and more specifically for the removal and replacement of oil filters.

2. Background of the Invnention

The hardest part of changing oil in an engine is manipulating the oil filter in either installing it or removing it in limited space, unknown positioning and slippery condition. To make matters worse is the old oil filter may sometimes be stuck and reaching it with a wrench in such limited space is almost impossible, causing many mechanics to be discouraged.

For these reasons, the art has included several proposals for various wrenches which can be used to manipulate an oil filter in an engine. Although these wrenches may work, there are great drawbacks in making the removal or installation difficult.

For example, some wrenches require screw adjustments, cloth coverings and loop adjustments all in very tight space. They do not facilitate the problems of stuck oil filters, slippery, out positioned filters and removal without damaging the filter. Other complication may include the requirement of great strength and agility by the manipulator. Not everyone is a professional with great strength, agility, and understanding of oil filter removal and installation.

Therefore, there is a need for a wrench that is not complicated, easy to secure, does not damage the oil filter, performs in limited space, and can be manipulated by even the weakest individual who is a novice.

### BRIEF SUMMARY OF THE INVENTION

The Alex Wrench is an oil filter wrench used primarily for automobile oil filters. It consists of two main parts—the wrench section and a handle. The wrench section itself is similar to that of standard oil filter wenches presently on the market. This section would consist of an adjustable band with a diameter approximating that of standard engine oil filters. The handle section, however, would be completely different. It would be formed from a relatively small diameter steel rod and extend upward for approximately 7 inches in a “unshaped” configuration instead of extending outward in a horizontal orientation. Thus; an individual would be provided with a substantial increase in leverage as compared to the wrenches now used. In use, the band would be slipped over the oil filter, self-tightening itself securely and with a slight turn, using the “U-shaped” handle, unscrewing the oil filter.

The “Alex Wrench” is an ideal tool for automotive technicians and “do-it-yourselfers”. Simplification features include:

1) It does not slip when oil is present on the surface of the oil filter

2) It does not require the user to occupy two hands in manipulating the device

3) It can be used for both installing and removing an oil filter

4) It does not puncture weaken or deform oil filter when using the “Alex Wrench”.

Appealing aspects are its shape, optimum size, light- weight, ease of use and method of unscrewing any round object approximately the size of a standard oil filter.

### BRIEF DESCRIPTION OF THE SEVERAL VIEWS OF THE DRAWING

Drawings

Drawing #1 is a front view of the Alex Wrench The handle portion of the invention is made of a round metal approximately 5 9/16 inches in height, 0.25 inches in width. The diameter across is approximately 4 inches.

Drawing #2 is an upright view of the coil. It is approximately 3.5 inches in diameter. It has an in-turning toothed end, out-turning end for size variance with an attachment approximately 0.11 inches in width to hold the self adjusting band and two exterior handle holes approximately 0.25 inches in diameter each.

Drawing #3 is the adjustable band. It is a band which is inserted around the coil. It is approximately 0.75 inches wide and 5.5 inches in length. It has two holes at each end approximately 0.25 inches in diameter.

Drawing #4 is a front view of the handle as described above with the self adjusting band attached.

### DETAILED DESCRIPTION OF THE INVENTION

The “Alex Wrench” is an oil filter wrench which has two main parts, a handle and an adjustable coil.

1) The handle portion as shown in drawing #1 is a small metal frame which is easily inserted into the adjustable coil portion either vertically or horizontally.

2) The coil portion is self adjusting with metal teeth in the internal part. See drawing #3

3) It has side pockets where the handle is inserted either horizontally or vertically. With a simple turn the adjustable coil wraps around the round oil filter gripping it with its teeth and is ready to install or remove. See drawing #4

1. Alex wrench has a new type of handle that is light, and compact as shown in Drawing #2.

2. Alex wrench is self-adjusting without any hinges or screws. It is a coil with a toothed end as shown in drawing #3 that wraps itself around the oil filter and grips it with a mere turn.

3. Alex wrench has a band that can be manipulated either horizontally or vertically as shown in drawing #4. It is attached to the toothed coil.

4. It is compact and easier to use then any of the wrenches researched.
